(19) United States
(12) Patent Application Publication
(10) Pub. No.: US 2008/0289605 A1
(43) Pub. Date: Nov. 27, 2008

(54) ACTUATOR CONTROL APPARATUS

(75) Inventor: Tokiji ITO, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/126,546

(22) Filed: May 23, 2008

(30) Foreign Application Priority Data
May 24, 2007 (JP) 2007-138203

(51) Int. Cl. F02D 13/00

(52) U.S. Cl. 123/435; 123/90.16

(57) ABSTRACT

An actuator control apparatus is provided which has: an actuator provided in an internal combustion engine at a position distant from combustion chambers to change an engine state amount; a sensor that detects the actual operation position of the actuator; a controller that controls the actuator to bring the actual operation position to a target operation position set based on the engine operation state; a diagnosis portion that diagnoses the actuator to be in an abnormal state when the deviation of the actual operation position from the target operation position has been larger than a reference amount for a reference time; and a setting portion that sets, upon the diagnosis by the diagnosis portion, the reference time such that the lower the engine coolant temperature, the longer the reference time, and the lower the ambient temperature, the longer the reference time corresponding to the engine coolant temperature.

### INCORPORATION BY REFERENCE

The disclosure of Japanese Patent Application No. 2007-138203 filed on May 24, 2007, including the specification, drawings and abstract is incorporated herein by reference in its entirety.

### BACKGROUND OF THE INVENTION

1. Field of the Invention

The invention relates to an actuator control apparatus having an actuator provided in an internal combustion engine at a position distant from a combustion chamber and operable to change a state amount of the internal combustion engine and a sensor that detects the actual operation position of the actuator, which apparatus is adapted to control the actuator so as to bring the actual operation position of the actuator to a target operation position set based on the operation state of the internal combustion engine.

2. Description of the Related Art

Japanese Patent Application Publication No. 2006-37787 (JP-A-2006-37787) describes a variable valve mechanism control apparatus that sets the target operation position of the variable vale mechanism corresponding to the target maximum lift of the intake valves. According to this control apparatus, the actual operation position of the variable valve mechanism is detected using a sensor, and the actual maximum lift of the intake valves is determined based on the result of detection by the sensor, and then a motor for driving the variable valve mechanism is controlled such that the actual maximum lift equals the target maximum lift.

When the variable valve mechanism is placed in an abnormal state due to, for example, foreign matter being jammed at movable portions of the variable valve mechanism, degraded oil sticking to the movable portions, and so on, the maximum lift of the intake valves becomes unable to be properly changed in accordance with the operation state of the internal combustion engine. According to the control apparatus described in JP-A-2006-37787, therefore, the state of the variable valve mechanism is diagnosed based on the deviation of the actual maximum lift of the intake valves from the target maximum lift, which deviation is obtained from the result of detection by the sensor. More specifically, if the deviation of the actual maximum lift from the target maximum lift has continuously been larger than a reference value for a reference time or longer, the state of the variable valve mechanism is diagnosed to be abnormal. That is, the state of the variable valve mechanism is diagnosed to be abnormal when the variable valve mechanism can not be driven or when the response of the variable valve mechanism is excessively low.

However, when the engine temperature is low, the viscosity of lubricant circulated to the respective movable portions of the variable valve mechanism is high, as compared to when the engine temperature is high. Under such low-temperature conditions, therefore, even if the state of the variable valve mechanism is normal, the response of the variable valve mechanism becomes temporarily low. As such, if the variable valve mechanism is diagnosed in the manner as described above even when the response of the variable valve mechanism is temporarily low due to a low temperature, the variable valve mechanism may be erroneously determined to be in an abnormal state.

To avoid such an erroneous diagnosis under low-temperature conditions, in the apparatus described in Japanese Patent Application Publication No. 2005-299677 (JP-A-2005-299677) which controls a hydraulically-driven variable valve mechanism for changing valve timings, the aforementioned reference time is changed in accordance with the temperature of hydraulic fluid supplied to the variable valve mechanism. Thus, the variable valve mechanism is diagnosed in consideration of the response of the variable valve mechanism that may change depending upon the viscosity of the hydraulic fluid.

As well as hydraulically driven variable valve mechanisms such as the one described in JP-A-2005-299677, preferably, the reference time is variably set in consideration of the viscosity of lubricant supplied to the movable portion of an electrically-driven variable valve mechanism. In this case, for example, as described in JP-A-2005-299617, in addition to setting the reference time in accordance with the temperature of the hydraulic fluid, the temperature of the movable portions of the variable valve mechanism is estimated based on, for example, the engine coolant temperature, and the reference time is made longer the lower the estimated temperature of the movable portions of the variable valve mechanism. Thus, the variable valve mechanism is diagnosed in consideration of the response of the variable valve mechanism.

However, a variable valve mechanism is usually provided in an engine body at a position distant from the combustion chambers, that is, at a position where the amount of heat transferred from the combustion chambers is relatively small. Therefore, in a state where the engine coolant temperature increases due to the heat generated at the combustion chambers but the temperature of the movable portions of the variable valve mechanism remains close to the ambient temperature (e.g., a state from a cold start of the engine to the end of the engine warming-up), the temperature of the movable portions of the variable valve mechanism becomes significantly lower than the engine coolant temperature. In such a case, the reference time is reduced as the engine coolant temperature increases despite the fact that the temperature of the movable portions of the variable valve mechanism is still low and the response of the variable valve mechanism is therefore low. As a result, the variable valve mechanism is erroneously diagnosed to be in an abnormal state despite that it is actually in a normal state, which is a problem.

As well as in the case where the reference time is changed in accordance with the engine coolant temperature, such a problem may occur also in the case where a reference value for determining the deviation of the actual maximum valve lift from the target maximum valve lift is set such that the lower the engine coolant temperature, the larger the reference value.

Although a variable valve mechanism for changing valve characteristics including the maximum lift of the valves of an internal combustion engine has been described above, it is to be understood that problems identical or similar to the one described above may occur to various other actuator control apparatuses that change an engine state amount by controlling the actual operation position of an actuator to its target operation position set based on the engine operation state.

### SUMMARY OF THE INVENTION

In view of the above, the invention has been made to provide an actuator control apparatus that improves the accuracy of diagnosis of an actuator.

An aspect of the invention relates to an actuator control apparatus, having:

an actuator provided in an internal combustion engine at a position distant from a combustion chamber and operable to change a state amount of the internal combustion engine; a sensor that detects an actual operation position of the actuator; a controller that controls the actuator so as to bring the actual operation position of the actuator to a target operation position set based on an operation state of the internal combustion engine; a diagnosis portion that diagnoses the actuator to be in an abnormal state when the deviation of the actual operation position from the target operation position has been larger than a reference amount for a reference time; and a setting portion that sets, upon the diagnosis by the diagnosis portion, the reference time such that the lower the temperature of engine coolant, the longer the reference time, and the lower an ambient temperature around the internal combustion engine, the longer the reference time corresponding to the temperature of the engine coolant.

According to the actuator control apparatus described above, in a state where the temperature of movable portions of the actuator is significantly lower than the temperature of the engine coolant (e.g., a state from a cold start of the internal combustion engine to the end of the warming-up of the internal combustion engine), the reference time, which is set according to the temperature of the engine coolant, is further extended according to the ambient temperature around the internal combustion engine. This minimizes the possibility of the actuator being erroneously diagnosed to be in an abnormal state when it is actually in a normal state. As a result, the accuracy of the diagnosis of the actuator improves.

Another aspect of the invention relates to an actuator control apparatus, having: an actuator provided in an internal combustion engine at a position distant from a combustion chamber and operable to change a state amount of the internal combustion engine; a sensor that detects an actual operation position of the actuator; a controller that controls the actuator so as to bring the actual operation position of the actuator to a target operation position set based on an operation state of the internal combustion engine; a diagnosis portion that diagnoses the actuator to be in an abnormal state when the deviation of the actual operation position from the target operation position has been larger than a reference amount for a reference time; and a setting portion that, upon the diagnosis by the diagnosis portion, sets the reference time such that the lower the temperature of engine coolant, the longer the reference time and sets the reference amount such that the lower an ambient temperature around the internal combustion engine, the larger the reference amount.

According to the actuator control apparatus described above, upon the diagnosis by the diagnosis portion, the reference amount is calculated as a function using the ambient temperature around the internal combustion engine as a variable such that the lower the ambient temperature, the larger the reference amount. Therefore, even in a state where the temperature of movable portions of the actuator is significantly lower than the temperature of the engine coolant (e.g., a state from a cold start of the internal combustion engine to the end of the warming-up of the internal combustion engine), the actuator is prevented from being erroneously diagnosed to be in an abnormal state when it is actually in a normal state. As a result, the accuracy of the diagnosis of the actuator improves.

Another aspect of the invention relates to an actuator control apparatus, having: an actuator provided in an internal combustion engine at a position distant from a combustion chamber and operable to change a state amount of the internal combustion engine; a sensor that detects an actual operation position of the actuator; a controller that controls the actuator so as to bring the actual operation position of the actuator to a target operation position set based on an operation state of the internal combustion engine; a diagnosis portion that diagnoses the actuator to be in an abnormal state when the deviation of the actual operation position from the target operation position has been larger than a reference amount for a reference time; and a setting portion that, upon the diagnosis by the diagnosis portion, sets the reference amount such that the lower the temperature of engine coolant, the larger the reference amount and such that the lower an ambient temperature around the internal combustion engine, the larger the reference amount.

According to the actuator control apparatus described above, in a state where the temperature of movable portions of the actuator is significantly lower than the temperature of the engine coolant (e.g., a state from a cold start of the internal combustion engine to the end of the warming-up of the internal combustion engine), the reference amount, which is set according to the temperature of the engine coolant, is further increased according to the ambient temperature around the internal combustion engine. This minimizes the possibility of the actuator being erroneously diagnosed to be in an abnormal state when it is actually in a normal state. As a result, the accuracy of the diagnosis of the actuator improves.

Another aspect of the invention relates to An actuator control apparatus, having: an actuator provided in an internal combustion engine at a position distant from a combustion chamber and operable to change a state amount of the internal combustion engine; a sensor that detects an actual operation position of the actuator; a controller that controls the actuator so as to bring the actual operation position of the actuator to a target operation position set based on an operation state of the internal combustion engine; a diagnosis portion that diagnoses the actuator to be in an abnormal state when the deviation of the actual operation position from the target operation position has been larger than a reference amount for a reference time; and a setting portion that, upon the diagnosis by the diagnosis portion, sets the reference amount such that the lower the temperature of engine coolant, the larger the reference amount and sets the reference time such that the lower an ambient temperature around the internal combustion engine, the longer the reference time.

According to the actuator control apparatus described above, upon the diagnosis by the diagnosis portion, the reference time is calculated as a function using the ambient temperature around the internal combustion engine as a variable such that the lower the ambient temperature, the longer the reference time. Therefore, even in a state where the temperature of movable portions of the actuator is significantly lower than the temperature of the engine coolant (e.g., a state from a cold start of the internal combustion engine to the end of the warming-up of the internal combustion engine), the actuator is prevented from being erroneously diagnosed to be in an abnormal state when it is actually in a normal state. As a result, the accuracy of the diagnosis of the actuator improves.

### BRIEF DESCRIPTION OF THE DRAWINGS

The foregoing and further features and advantages of the invention will be better understood by reading the following detailed description of preferred embodiments of the invention, when considered in connection with the accompanying drawings, in which:

FIG. 1 is a cross-sectional view cutting through a portion an internal combustion engine incorporating a variable valve mechanism control apparatus according to an example embodiment of the invention and a variable valve mechanism controlled by said control apparatus;

FIG. 2 is a perspective cutaway view showing the internal structure of an intermediate drive mechanism in the example embodiment of the invention;

FIG. 3 is a block diagram illustrating the relation between a brushless motor and an electronic control unit for controlling the brushless motor in the example embodiment of the invention;

FIG. 4 is a graph representing how the temperature of the movable portions of the variable valve mechanism and the temperature of the engine coolant changes after engine start;

FIG. 5 is a flowchart illustrating in detail a diagnosis routine that the electronic control unit executes to diagnose the variable valve mechanism in the example embodiment of the invention;

FIG. 6 is a flowchart illustrating in detail a procedure that the electronic control unit executes to set a reference time in the example embodiment of the invention;

FIG. 7 is a map defining the relation between the engine coolant temperature and the reference time in the example embodiment of the invention;

FIG. 8 is another map defining the relation between the engine coolant temperature and the reference time;

FIG. 9 is another map defining the relation between the engine coolant temperature and the reference time; and

FIG. 10 is another map defining the relation between the engine coolant temperature and the reference time.

### DETAILED DESCRIPTION OF THE EMBODIMENTS

In the following description and the accompanying drawings, the present invention will be described in greater detail with reference to the example embodiments.

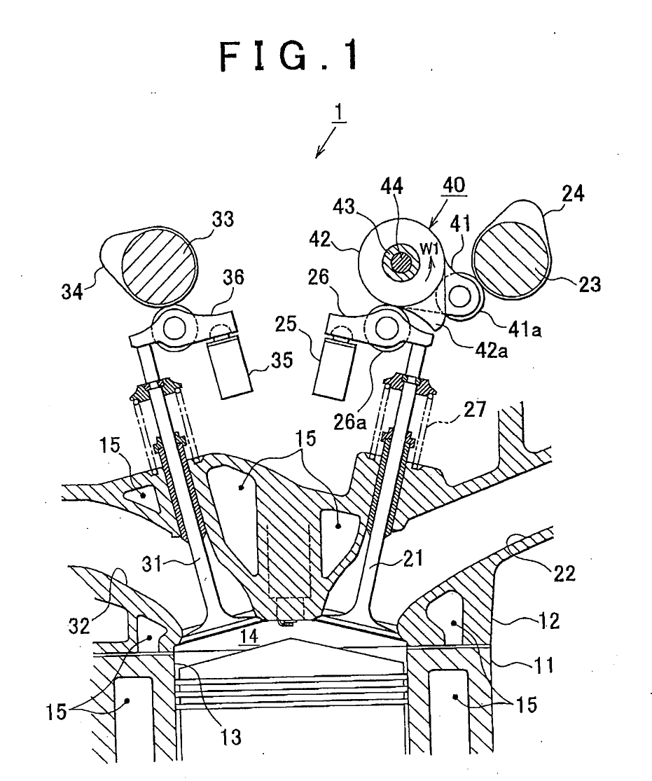

Hereinafter, with reference to FIG. 1 to FIG. 7, example embodiments of the invention will be described which are applied to a variable valve mechanism operable to change the maximum lift of the intake valves, which is one of state amounts of an internal combustion engine for vehicles. FIG. 1 is a cross-sectional view cutting through a portion of the internal combustion engine.

Referring to FIG. 1, a plurality of cylinders 13 is formed in a cylinder block 11 of an internal combustion engine 1, and intake ports 22 and exhaust ports 32 are formed in a cylinder head 12 such that they communicate with combustion chambers 14 in the respective cylinders 13, and the cylinder head 12 is mounted on the cylinder block 11. In the cylinder head 12, intake valves 21 for opening and closing the intake ports 22 and exhaust valves 31 for opening and closing the exhaust ports 32 are provided for the respective cylinders 13. An water jacket 15 for circulating engine coolant is formed in the cylinder block 11 and the cylinder head 12, extending around the respective combustion chambers 14.

An intake camshaft 23 and an exhaust camshaft 33 are rotatably supported on the cylinder head 12. As the intake camshaft 23 and the exhaust camshaft 33 rotate, intake cams 24 provided on the intake camshaft 23 and exhaust cams 34 provided on the exhaust camshaft 33 rotate together, whereby rocker arms 26, 36 pivot up and down about lash adjusters 25, 35, driving the intake valves 21 and the exhaust valves 31 up and down, respectively.

The rocker arms 36 are directly pressed by the exhaust cams 34. On the other hand, the rocker arms 26 are indirectly pressed by the intake cams 24 via an intermediate drive mechanism 40. The intermediate drive mechanism 40 has input portions 41 and output portions 42. The input portions 41 and the output portions 42 are pivotally supported on a support pipe 43 fixed on the cylinder head 12. Each rocker arm 26 is urged toward the output portion 42 side by the urging forces of the rocker arm 25 and a valve spring 27, whereby a roller 26a at the center of the rocker arm 26 is kept in contact with the outer peripheral face of the output portion 42. As such, the output portions 42 of the intermediate drive mechanism 40 are pivotally urged, together with the input portions 41, in the counterclockwise direction W1, whereby rollers 41a at the tips of the radially projecting portions of the respective input portions 41 press the outer peripheral faces of the respective intake cams 24. According to this structure, as the intake cams 24 rotate during the engine operation, the intake cams 24 press the respective input portions 41 while sliding on the rollers 41a of the input portions 41, whereby the output portions 42 pivot up and down about the support pipe 43. As the output portions 42 thus pivot, the rocker arms 26 pivot up and down about the lash adjustors 25, driving the intake valves 21 up and down.

A control shaft 44 is provided in the support pipe 43 such that it can move axially. The control shaft 44 is drivingly connected to the input portions 41 and the output portions 42 via connection members. As the control shaft 44 axially moves in the support pipe 43, the relative phase difference between the input portions 41 and the output portions 42 changes accordingly.

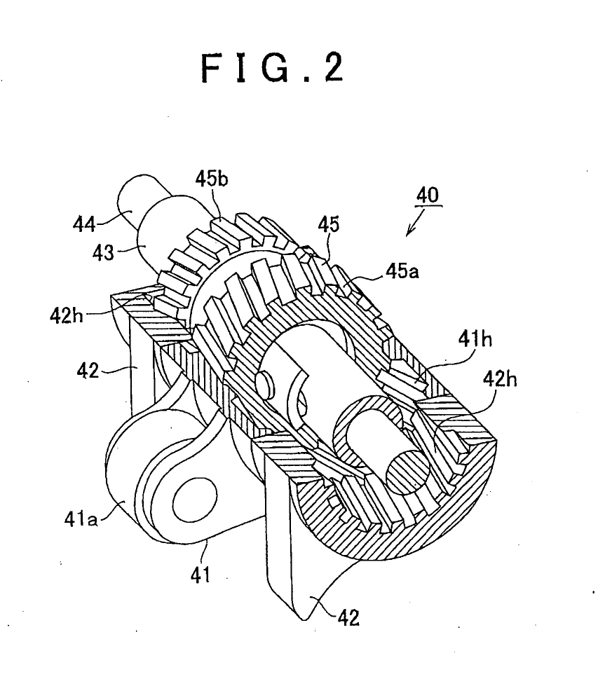

Next, referring to FIG. 2, detailed descriptions will be made of the internal structure of the intermediate drive mechanism 40 and the mechanism for changing the relative phase difference between the input portions 41 and the output portions 42. FIG. 2 is a perspective cutaway view showing the internal structure of the intermediate drive mechanism 40.

Referring to FIG. 2, each input portion 41 is provided between a pair of the output portions 42, and a cylindrical communication space is formed through the inside of the input portion 41 and the insides of the two output portions 41. A helical spline 41h is formed on the inner peripheral face of the input portion 41, while a helical spline 42h is formed on the inner peripheral face of each output portion 42. The helical spline 41h and the helical spline 42h are slanted toward the opposite sides. A cylindrical slider gear assembly 45 is provided in the communication space extending through the inside of the input portions 41 and the insides of the output portions 42. A helical spline 45a is formed on the outer peripheral face of the axial center portion of the slider gear assembly 45. The helical spline 45a is meshed with the helical spline 41h of the input portion 41. Helical splines 45b are formed on the outer peripheral faces of the axial end portions of the slider gear assembly 45. The helical splines 45b are meshed with the helical splines 42h of the output portions 42, respectively. The support pipe 43, in which the control shaft 44 is provided, is arranged in the inner space of the slider gear assembly 45. At the root end of the control shaft 44 is provided a brushless motor 60 for moving the control shaft 44 axially. The brushless motor 60 is controlled by an electronic control unit 5, which will be described later. Note that lubricant is circulated to the meshing faces of the input portions 41, the output portions 42, and the slider gear assembly 45, and the slide contact faces of the support pipe 43 and the control shaft 44 via respective lubricant passages, which are not shown in the drawings.

According to the intermediate drive mechanism 40 thus configured, as the control shaft 44 axially moves, the slider gear assembly 45 axially moves. Because the helical splines 45a, 45b at the outer peripheral faces of the slider gear assembly 45 are in mesh with the helical splines 41h, 42h at the inner peripheral faces of the input portion 41 and the output portions 42, as the slider gear assembly 45 axially moves, the input portion 41 and the output portions 42 rotate in opposite directions, whereby the relative phase difference between the input portion 41 and the output portions 42 changes and thus the maximum lift of the intake valve 21 changes.

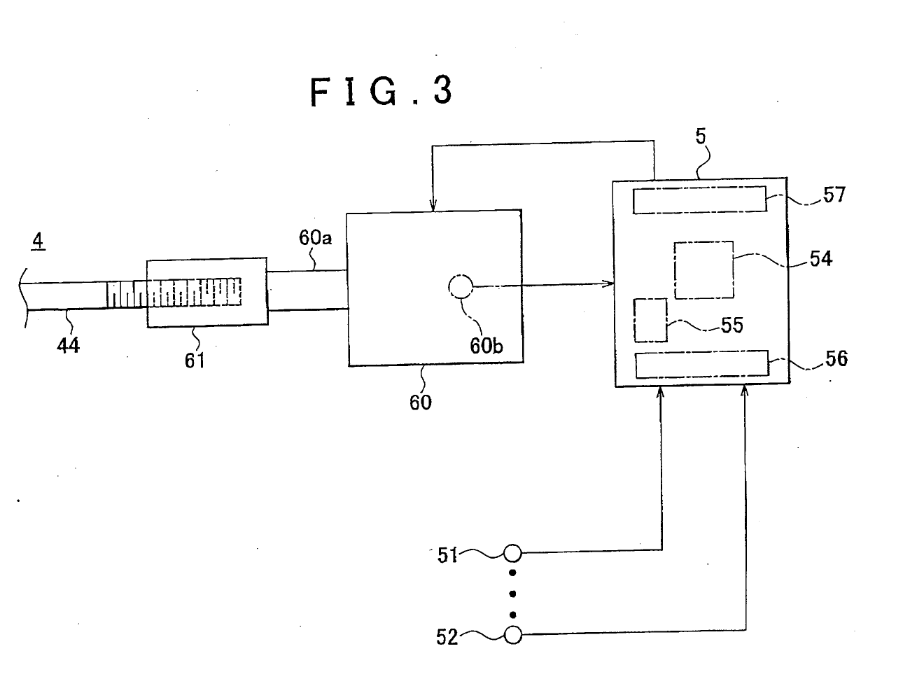

The block diagram of FIG. 3 illustrates the relation between the brushless motor 60 and the electronic control unit 5 for controlling the brushless motor 60 in the variable valve mechanism 4. Referring to FIG. 3, the root end of the control shaft 44 (the end of the control shaft 44 on the right side in FIG. 3) is coupled with an output shaft 60a of the brushless motor 60 via a conversion mechanism 61. The conversion mechanism 61 is provided to convert the rotation of the output shaft 60a into a linear motion in the axial direction of the control shaft 44. That is, as the output shaft 60a rotates in the normal and reverse directions, the rotation of the output shaft 60a is converted into reciprocation of the control shaft 44 via the conversion mechanism 61. The operation portion of the conversion mechanism 61 is filled with lubricant having a relatively high viscosity. The brushless motor 60 is provided with an operation position sensor 60b for detecting the rotational phase of the brushless motor 60, that is, the actual operation position of the variable valve mechanism 4. The signals output from the operation position sensor 60b are provided to the electronic control unit 5.

The electronic control unit 5 is constituted of a CPU (Central Processing Unit) 54 for executing various control routines for controlling the internal combustion engine 1, a memory 55 for storing various control programs and various information necessary for controlling the internal combustion engine 1, an input port 56 to which various signals are input externally, an output port 57 from which various signals are output externally, and so on. The input port 56 is connected to an engine coolant temperature sensor 51 that detects the temperature of engine coolant circulated in the water jacket 15 (will be referred to as “coolant temperature ThW”) and to an intake air temperature sensor 52 that detects the temperature of intake air (will be referred to as “intake air temperature ThA”). The intake air temperature ThA detected by the intake air temperature sensor 52 is used as a parameter for setting the mode of diagnosis of the variable valve mechanism 4 and as a parameter for correction of the fuel injection amount. Meanwhile, the brushless motor 60 is connected to the output 57.

The control portion of the electronic control unit 5 is adapted to set a target maximum lift of the intake valves 21 in accordance with given engine operation parameters including the engine speed and the intake amount and detect the actual operation position of the variable valve mechanism 4 from the result of detection by the operation position sensor 60b, that is, an actual maximum lift VLc of the intake valves 21. Then, the control portion of the electronic control unit 5 executes feedback control to the brushless motor 60 such that the actual maximum lift VLc equals the target maximum lift VLt.

When the variable valve mechanism 4 is placed in an abnormal state due to, for example, foreign matter being jammed at movable portions of the intermediate drive mechanism 40 and the variable valve mechanism 61, degraded oil sticking to the movable portions, and so on, the maximum lift of the intake valves 21 becomes unable to be properly changed in accordance with the operation state of the internal combustion engine 1.

Therefore, the variable valve mechanism 4 is diagnosed based on the deviation of the actual maximum lift VLc from the target maximum lift VLt. In this diagnosis, the state of the variable valve mechanism 4 is determined to be abnormal if the deviation of the actual maximum lift VLc from the target maximum lift VLt has continuously been equal to or larger than a reference value (will be referred to as “reference value A”) for a reference time (will be referred to as “reference time R”). In short, in this diagnosis, the state of the variable valve mechanism 4 is determined to abnormal if the variable valve mechanism 4 can not be driven or if the response of the variable valve mechanism 4 is excessively low.

Meanwhile, the lower the engine temperature, the higher the viscosity of lubricant circulated to the respective movable portions of the variable valve mechanism 4. Therefore, for example, when the engine temperature is still low after engine start, the frictions at the movable portions are relatively high, making the response of the variable valve mechanism 4 temporarily low. Thus, if the state of the variable valve mechanism 4 is diagnosed in the above-described manner even when the response of the variable valve mechanism 4 is temporarily low at a low temperature, the variable valve mechanism 4 may be erroneously determined to be in an abnormal state.

In view of this, in this example embodiment of the invention, the reference time R is set in consideration of the response of the variable valve mechanism 4 that changes depending upon the viscosity of the lubricant for lubricating the movable portions of the variable valve mechanism 4. To implement this, more specifically, a temperature ThV of the movable portions of the variable valve mechanism 4 is estimated from the engine coolant temperature ThW, and the reference time R is variably set such that the lower the estimated temperature ThV of the movable portions of the variable valve mechanism 4, the longer the reference time R.

Meanwhile, the variable valve mechanism 4 is arranged in the cylinder head 12 at a position distant from the combustion chambers 14, that is, a position where the amount of heat transferred from the combustion chambers 14 is relatively small. Therefore, in some particular states (e.g., a state from a cold start of the engine to the end of the engine warming-up), the temperature of the movable portions of the variable valve mechanism 4 remains close to the ambient temperature while the engine coolant temperature increases due to the heat generated at the combustion chambers 14. In this case, the temperature of the movable portions of the variable valve mechanism becomes significantly lower than the engine coolant temperature.

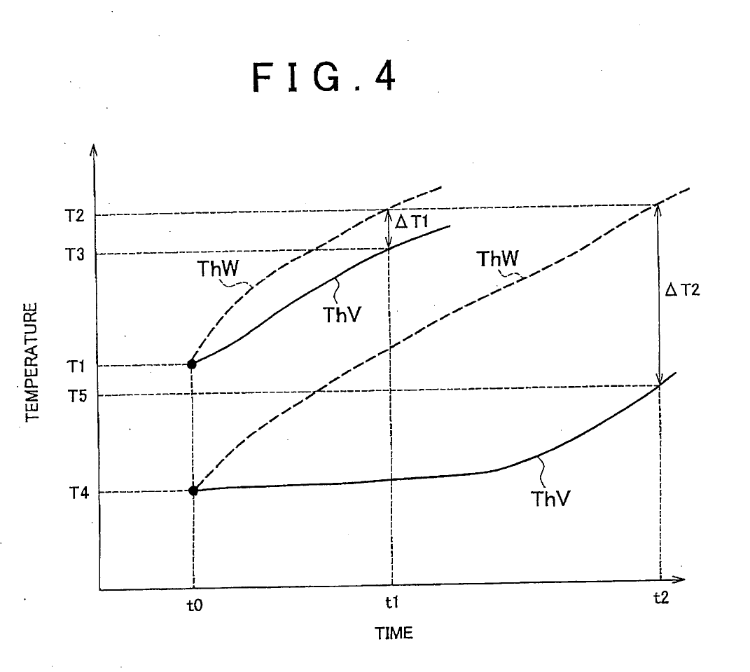

Hereinafter, with reference to the graph of FIG. 4, a description will be made of how the temperature ThV of the movable portions of the variable valve mechanism 4 and the engine coolant temperature ThW change during the warming-up of the internal combustion engine 1. In the graph of FIG. 4, the solid curves represent the temperature ThV of the movable portions of the variable valve mechanism 4, and the dotted curves represent the engine coolant temperature ThW.

The solid and dotted curves in the upper side of in FIG. 4 illustrate an example case where the ambient temperature around the internal combustion engine 1 is high and therefore the temperature ThV of the movable portions of the variable valve mechanism 4 and the engine coolant temperature ThW are equal to temperature T1, which is relatively high, immediately before the start of the internal combustion engine 1, and the internal combustion engine 1 is started at time to, so that the temperature ThV of the movable portions of the variable valve mechanism 4 and the engine coolant temperature ThW both increase due to the heat generated at the combustion chambers 14. In this case, because the variable valve mechanism 4 is provided at a position where the amount of heat transferred from the combustion chambers 14 is relatively small, the engine coolant temperature ThW increases and reaches temperature T2 (T2>T1) at time t1 while the temperature ThV of the movable portions of the variable valve mechanism 4 increases but only reaches temperature T3 that is lower than the engine coolant temperature ThW (=T2) by ΔT1 (T1<T3<T2) at time t1.

On the other hand, the solid and dotted curves in the lower side of FIG. 4 illustrates an example case where the ambient temperature around the internal combustion engine 1 is low and therefore the temperature ThV of the movable portions of the variable valve mechanism 4 and the engine coolant temperature ThW are equal to temperature T4 (T4<T1), which is relatively low, immediately before the start of the internal combustion engine 1, and the internal combustion engine 1 is started at time to, so that the temperature ThV of the movable portions of the variable valve mechanism 4 and the engine coolant temperature ThW both increase due to the heat generated at the combustion chambers 14. In this case, the temperatures ThV and ThW gradually increase as compared to when the ambient temperature around the internal combustion engine 1 is high. Therefore, the engine coolant temperature ThW increases and reaches temperature T2 (T2>T4) at time t2, which is later than time t1, while the temperature ThV of the movable portions of the variable valve mechanism 4 increases but only reaches temperature T5 (T5<<T2) that is lower than the engine coolant temperature ThW (=T2) by ΔT2 (ΔT2>>ΔT1) at time t2.

As such, when the temperature ThV of the movable portions of the variable valve mechanism 4 is significantly lower than the engine coolant temperature ThW, the reference time R is made shorter as the engine coolant temperature ThW increases despite that the temperature of the movable portions of the variable valve mechanism 4 is still low. Therefore, the variable valve mechanism 4 may be erroneously be diagnosed to be in an abnormal state despite that it is actually in a normal state. In view of this, in this example embodiment of the invention, the reference time R is set such that the lower the engine coolant temperature ThW, the longer the reference time R, and the lower the intake air temperature ThA, the longer the reference time R corresponding to the engine coolant temperature ThW.

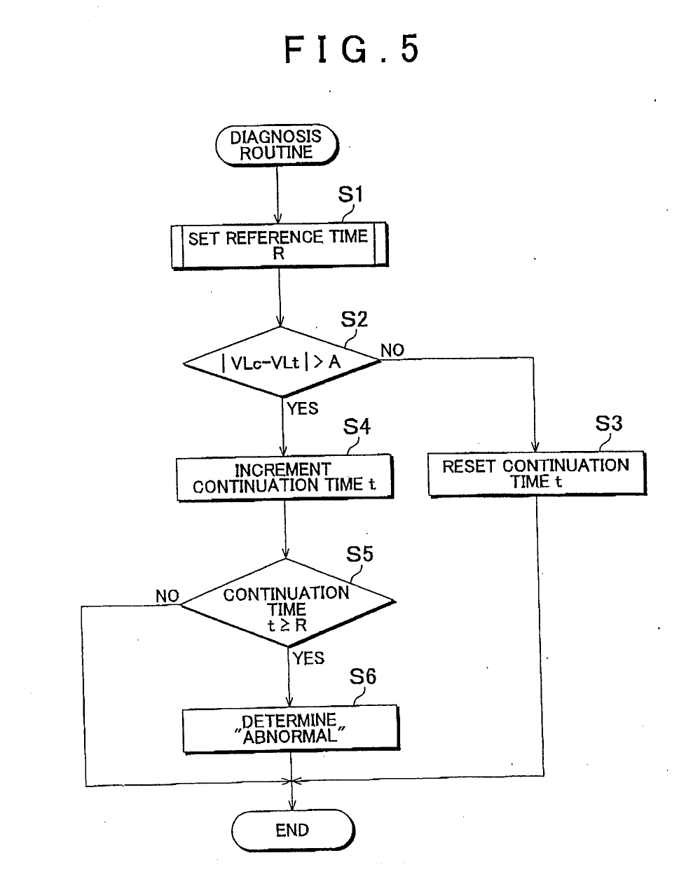

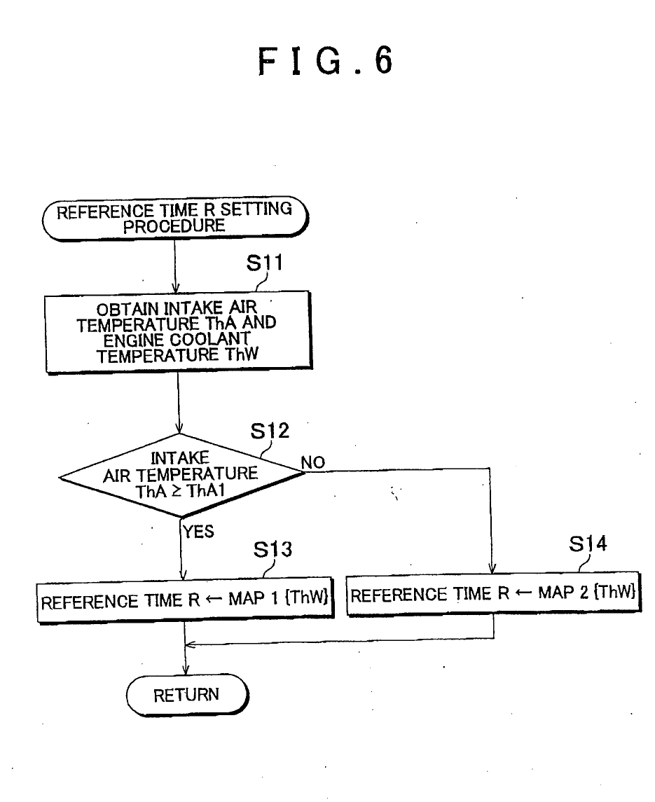

In the following, the procedure for diagnosing the variable valve mechanism 4 will be described with reference to FIG. 5 to FIG. 7. The flowchart of FIG. 5 illustrates a diagnosis routine executed to diagnose the variable valve mechanism 4. This diagnosis routine is repeatedly executed by the electronic control unit 5 at given time intervals. The flowchart of FIG. 6 illustrates a reference time setting procedure executed in the diagnosis routine shown in FIG. 5 to set the reference time R.

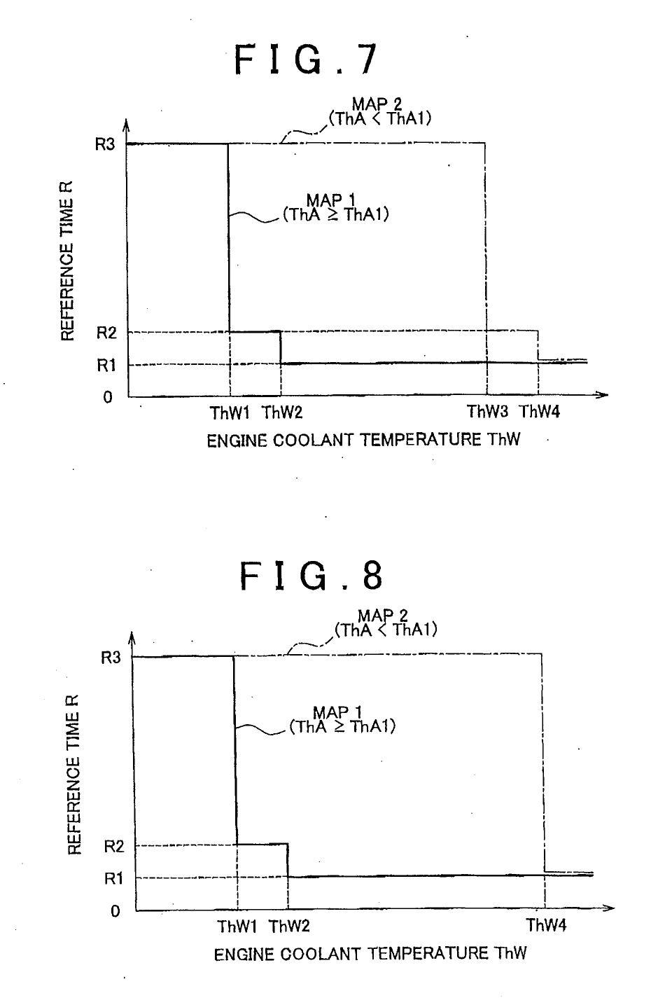

After the start of the diagnosis routine shown in FIG. 5, the reference time setting procedure is first executed to set the reference time R (step S1). Referring to FIG. 6, in the reference time setting procedure, the present intake air temperature ThA and the present coolant temperature ThW are obtained (step S11), and it is then determined whether the obtained intake air temperature ThA is equal to or higher than a reference intake air temperature ThA1 (step S12). That is, in this step, it is determined whether the ambient temperature around the internal combustion engine 1 is low. If the intake air temperature ThA is lower than the reference intake air temperature ThA1 (step S12: “NO”), it indicates that the ambient temperature around the internal combustion engine 1 is presently low. In this case, the reference time R is set by applying the engine coolant temperature ThW to a second map (MAP 2) shown in FIG. 7 (step S14), after which the reference time setting procedure is finished.

On the other hand, if the intake air temperature ThA is equal to or higher than the reference intake air temperature ThA1 (step S12: “YES”), it indicates that the ambient temperature around the internal combustion engine 1 is presently high. In this case, the reference time R is set by applying the engine coolant temperature ThW to a first map (MAP 1) shown in FIG. 7 (step S13), after which the reference time setting procedure is finished.

Hereinafter, with reference to the maps in FIG. 7, a description will be made of the relation between the engine coolant temperature ThW and the reference time R when the intake air temperature ThA is low. It is to be noted that in FIG. 7 the first map (MAP 1) that is used when the intake air temperature ThA is equal to or higher than the reference intake air temperature ThA1 is drawn by solid lines and the second map (MAP 2) that is used when the intake air temperature ThA is lower than the reference intake air temperature ThA1 is drawn by single-dotted lines.

According to the first map (MAP 1) drawn by the solid lines in FIG. 7, when the engine coolant temperature ThW is lower than a reference coolant temperature ThW1, the reference time R is set to time R3, and when the engine coolant temperature ThW is equal to or higher than the reference coolant temperature ThW1 and lower than a reference coolant temperature ThW2, the reference time R is set to time R2 (R2<R3), and when the engine coolant temperature ThW is equal to or higher than the reference coolant temperature ThW2, the reference time R is set to time R1 (R1<R3). That is, when the engine coolant temperature ThW is low, the viscosity of the lubricant is high and therefore the response of the variable valve mechanism 4 is low as compared to when the engine coolant temperature ThW is high. Therefore, the first map is formulated such that the reference time R is made longer the lower the engine coolant temperature ThW.

According to the second map (MAP 2) drawn by the single-dotted lines in FIG. 7, on the other hand, when the engine coolant temperature ThW is lower than a reference coolant temperature ThW 3, the reference time R is set to time R3, and when the engine coolant temperature ThW is equal to or higher than the reference coolant temperature ThW3 and lower than a reference coolant temperature ThW4, the reference time R is set to time R2, and when the engine coolant temperature TbW is equal to or higher than the reference coolant temperature ThW4, the reference time R is set to time R1. That is, when the engine coolant temperature ThW is equal to or higher than the engine coolant temperature ThW 1, the reference time R set by the second map (MAP 2) is longer than that set by the first map (MAP 1).

Referring back to the flowchart of FIG. 5, after the reference time R has been set in the reference time setting procedure described above, it is determined whether the present deviation of the actual maximum lift VLc from the target maximum lift VLt, that is, the absolute deviation therebetween (=¦VLt−VLc¦) is larger than the reference value A (step S2). At this time, if the absolute deviation is smaller than the reference value A (step S2: “NO”), that is, if the difference between the target maximum lift VLt and the actual maximum lift VLc is smaller than the reference value A, a continuation time t is reset to zero (step S3), after which the present cycle of the diagnosis routine is finished. The continuation time t represents the time for which the absolute deviation of the actual maximum lift VLc from the target maximum lift VLt continues to be equal to or larger than the reference value A.

On the other hand, if the absolute deviation of the actual maximum lift VLc from the target maximum lift VLt is equal to or larger than the reference value A (step S2: “YES”), that is, if the difference between the target maximum lift VLt and the actual maximum lift VLc is equal to or larger than the reference valve A, the continuation time t is incremented (step S4). Then, it is determined whether the incremented continuation time t is equal to or longer than the reference time R set in the above-described reference time setting procedure (step S5). At this time, if the continuation time t is shorter than the reference time R (step S5: “NO”), the variable valve mechanism 4 is not determined to be in an abnormal state, and therefore the present cycle of the diagnosis routine is finished.

On the other hand, if the continuation time t is equal to or longer than the reference time R (step S5: “YES”), the variable valve mechanism 4 is determined to be in an abnormal state (step S6), after which the present cycle of the diagnosis routine is finished. Thus, the electric variable valve mechanism control apparatus of this example embodiment provides the following effects and advantages.

(1) In the foregoing example embodiment, as described above, the lower the engine coolant temperature ThW, the longer the reference time R, and the lower the intake air temperature ThA, the longer the reference time R corresponding to the engine coolant temperature ThW. Therefore, in a state where the temperature ThV of the movable portions of the variable valve mechanism 4 is significantly lower than the engine coolant temperature ThW (e.g., a state from a cold start of the engine to the end of the engine warming-up), the reference time R, which is set according to the engine coolant temperature ThW, is further extended according to the intake air temperature ThA. This minimizes the possibility of the variable valve mechanism 4 being erroneously diagnosed to be an abnormal state when it is actually in a normal state. As a result, the accuracy of the diagnosis of the variable valve mechanism 4 improves.

(2) In the foregoing example embodiment, the ambient temperature around the internal combustion engine 1 is obtained from the intake air temperature ThA detected by the intake air temperature sensor 52, which is mainly used for correcting the fuel injection amount. Thus, the system configuration is relatively simple as compared to a case where an additional ambient temperature sensor is provided to obtain the ambient temperature around the internal combustion engine 1.

It is to be noted that the invention is not limited to the constructions and arrangements employed in the foregoing example embodiment. On the contrary, the invention may be embodied as various other actuator control apparatuses, such as those described below.

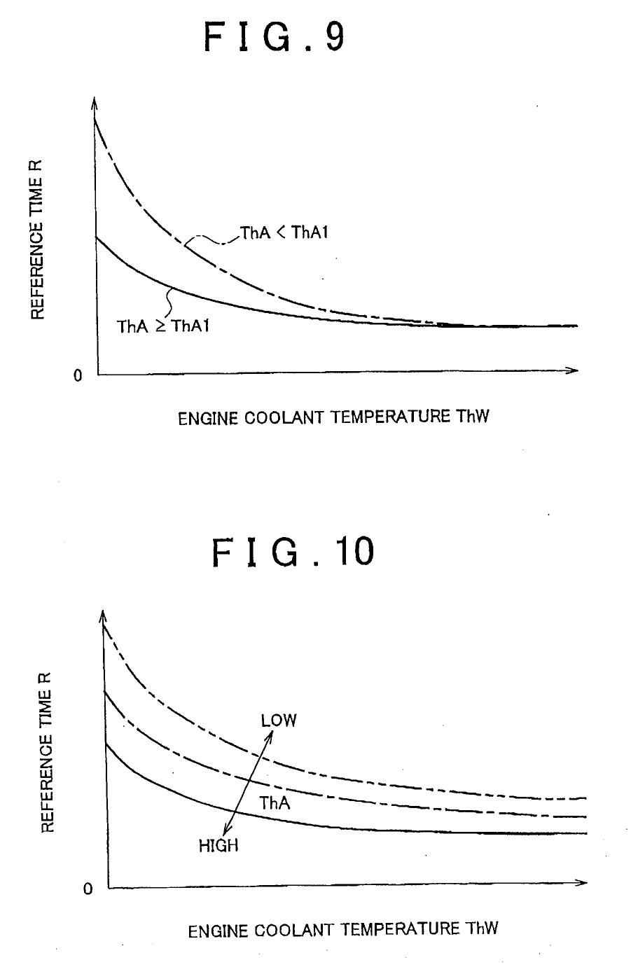

(i) While the reference time R is set using the maps shown in FIG. 7 in the foregoing example embodiment, the relation between the engine coolant temperature ThW and the reference time R may be set otherwise. For example, the maps of FIG. 8 may alternatively be used to set the reference time R. According to these maps, the reference time R is differently set according to the engine coolant temperature ThW from the maps in FIG. 7 when the intake air temperature ThA is lower than the reference intake air temperature ThA 1. Further, according to the maps in FIG. 7 and the maps in FIG. 8, the reference time R is changed in steps as the engine coolant temperature ThW changes. Alternatively, the reference time R may be continuously changed as the engine coolant temperature ThW changes as in the maps of FIG. 9. In this case, too, the lower the intake air temperature ThA, the longer the reference time R is made. Further, as in the maps of FIG. 10, the reference time R may be continuously changed as the intake air temperature ThA changes.

(ii) While the difference between the target maximum lift VLt and the actual maximum lift VLc has been determined by calculating the absolute deviation of the actual maximum lift VLC from the target maximum lift VLt in the foregoing example embodiment, said difference may be determined otherwise. For example, the difference between the target maximum lift VLt and the actual maximum lift VLc may be determined based on the ratio between the target maximum lift VLt and the actual maximum lift VLc (=VLt/VLc, or VLc/VLt).

(iii) While the ambient temperature around the internal combustion engine 1 has been detected using the intake air temperature sensor 52 in the foregoing example embodiment, it may be obtained otherwise. For example, an outside temperature sensor may alternatively be used.

(iv) The foregoing example embodiment provides an electrically-driven actuator control apparatus that diagnoses an actuator, that is, the variable valve mechanism 4, to be in an abnormal state when the deviation of the actual operation position of the actuator from its target operation position has continuously been larger than a reference amount for a reference time, and when diagnosing the actuator, the reference time R is made longer the lower the engine coolant temperature ThW, and the reference time R corresponding to the engine coolant temperature ThW is made longer the lower the ambient temperature around the internal combustion engine 1. However, the parameters for the diagnosis of the actuator are not limited to those described above. For example, the reference value A, which is used to determine the magnitude of the deviation of the actual operation position of the actuator from the target operation position, may be changed in addition to or instead of the reference time period R, as in the following examples. In these examples, effects and advantages identical or similar to those described above can be obtained.

First, as the first modification example of the foregoing example embodiment, when diagnosing the actuator, the reference time R may be made longer the lower the engine coolant temperature ThW and the reference value A may be made larger the lower the ambient temperature around the internal combustion engine 1.

Further, as the second modification example of the foregoing example embodiment, when diagnosing the actuator, the reference value A may be made larger the lower the engine coolant temperature ThW, and the reference value A corresponding to the engine coolant temperature ThW may be made larger the lower the ambient temperature around the internal combustion engine 1.

Further, as the third modification example of the foregoing example embodiment, when diagnosing the actuator, the reference value A may be made larger the lower the engine coolant temperature ThW, and the reference time R may be made longer the lower the ambient temperature around the internal combustion engine 1.

(v) Further, the invention may be embodied as a throttle opening degree control apparatus that changes the opening degree of a throttle valve as an engine state amount. In this case, a diagnosis portion of an electronic control unit for controlling the throttle opening degree control apparatus may be adapted to diagnose said apparatus to be in an abnormal state if the difference between the target opening degree and the actual opening degree of the throttle valve has continuously been larger than a reference amount for a reference time.

(vi) Further, while the variable valve mechanism in the foregoing example embodiment is operable to change the maximum lift of the intake valves 21, the invention may be embodied as control apparatuses for controlling actuators that change, as engine state amounts, various other valve characteristics including the valve-opening timing, the valve-closing timing, the valve-opening-closing timing, and various combinations among them, as well as or instead of the maximum valve lifts. Further, the invention may be embodied as control apparatuses for controlling actuators that change the valve characteristics of the exhaust valves as well as or instead of the valve characteristics of the intake valves. Further, the invention is not limited to applications of eclectically-driven actuators, but it may be applied to various other actuators including hydraulically-driven actuators.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. An actuator control apparatus, comprising:
an actuator provided in an internal combustion engine at a position distant from a combustion chamber and operable to change a state amount of the internal combustion engine;
a sensor that detects an actual operation position of the actuator;
a controller that controls the actuator so as to bring the actual operation position of the actuator to a target operation position set based on an operation state of the internal combustion engine;
a diagnosis portion that diagnoses the actuator to be in an abnormal state when the deviation of the actual operation position from the target operation position has been larger than a reference amount for a reference time; and
a setting portion that sets, upon the diagnosis by the diagnosis portion, the reference time such that the lower the temperature of engine coolant, the longer the reference time, and the lower an ambient temperature around the internal combustion engine, the longer the reference time corresponding to the temperature of the engine coolant.

2. The actuator control apparatus according to claim 1, wherein
the ambient temperature around the internal combustion engine is detected by an intake air temperature sensor provided at the internal combustion engine.

3. The actuator control apparatus according to claim 1, wherein
the actuator is operable to change, as the state amount of the internal combustion engine, at least one of valve characteristics including the timing for opening an intake valve of the internal combustion engine, the timing for closing the intake valve, and the maximum lift of the intake valve.

4. The actuator control apparatus according to claim 3, wherein
the actuator is a variable valve mechanism operable to change the maximum lift of the intake valve.

5. The actuator control apparatus according to claim 1, wherein
the actuator is operable to change, as the state amount of the internal combustion engine, at least one of valve characteristics including the timing for opening an exhaust valve of the internal combustion engine, the timing for closing the exhaust valve, and the maximum lift of the exhaust valve.

6. The actuator control apparatus according to claim 5, wherein
the actuator is a variable valve mechanism operable to change the maximum lift of the exhaust valve.

7. The actuator control apparatus according to claim 1, wherein
the actuator is an electrically-driven actuator.

8. The actuator control apparatus according to claim 1, wherein
the actuator is operable to change the opening degree of a throttle valve of the internal combustion engine as the state amount of the internal combustion engine, and the sensor is adapted to detect the actual opening degree of the throttle valve by detecting the actual operation position of the actuator.

9. An actuator control apparatus, comprising:
an actuator provided in an internal combustion engine at a position distant from a combustion chamber and operable to change a state amount of the internal combustion engine;
a sensor that detects an actual operation position of the actuator;
a controller that controls the actuator so as to bring the actual operation position of the actuator to a target operation position set based on an operation state of the internal combustion engine;
a diagnosis portion that diagnoses the actuator to be in an abnormal state when the deviation of the actual operation position from the target operation position has been larger than a reference amount for a reference time; and
a setting portion that, upon the diagnosis by the diagnosis portion, sets the reference time such that the lower the temperature of engine coolant, the longer the reference time and sets the reference amount such that the lower an ambient temperature around the internal combustion engine, the larger the reference amount.

10. The actuator control apparatus according to claim 9, wherein
the ambient temperature around the internal combustion engine is detected by an intake air temperature sensor provided at the internal combustion engine.

11. The actuator control apparatus according to claim 9, wherein
the actuator is operable to change, as the state amount of the internal combustion engine, at least one of valve characteristics including the timing for opening an intake valve of the internal combustion engine, the timing for closing the intake valve, and the maximum lift of the intake valve.

12. The actuator control apparatus according to claim 11, wherein
the actuator is a variable valve mechanism operable to change the maximum lift of the intake valve.

13. The actuator control apparatus according to claim 9, wherein
the actuator is operable to change, as the state amount of the internal combustion engine, at least one of valve characteristics including the timing for opening an exhaust valve of the internal combustion engine, the timing for closing the exhaust valve, and the maximum lift of the exhaust valve.

14. The actuator control apparatus according to claim 13, wherein
the actuator is a variable valve mechanism operable to change the maximum lift of the exhaust valve.

15. The actuator control apparatus according to claim 9, wherein
the actuator is an electrically-driven actuator.

16. The actuator control apparatus according to claim 9, wherein
the actuator is operable to change the opening degree of a throttle valve of the internal combustion engine as the state amount of the internal combustion engine, and the sensor is adapted to detect the actual opening degree of the throttle valve by detecting the actual operation position of the actuator.

17. An actuator control apparatus, comprising:
an actuator provided in an internal combustion engine at a position distant from a combustion chamber and operable to change a state amount of the internal combustion engine;
a sensor that detects an actual operation position of the actuator;
a controller that controls the actuator so as to bring the actual operation position of the actuator to a target operation position set based on an operation state of the internal combustion engine;
a diagnosis portion that diagnoses the actuator to be in an abnormal state when the deviation of the actual operation position from the target operation position has been larger than a reference amount for a reference time; and
a setting portion that, upon the diagnosis by the diagnosis portion, sets the reference amount such that the lower the temperature of engine coolant, the larger the reference amount and such that the lower an ambient temperature around the internal combustion engine, the larger the reference amount.

18. The actuator control apparatus according to claim 17, wherein
the ambient temperature around the internal combustion engine is detected by an intake air temperature sensor provided at the internal combustion engine.

19. The actuator control apparatus according to claim 17, wherein
the actuator is operable to change, as the state amount of the internal combustion engine, at least one of valve characteristics including the timing for opening an intake valve of the internal combustion engine, the timing for closing the intake valve, and the maximum lift of the intake valve.

20. The actuator control apparatus according to claim 19, wherein
the actuator is a variable valve mechanism operable to change the maximum lift of the intake valve.

21. The actuator control apparatus according to claim 17, wherein
the actuator is operable to change, as the state amount of the internal combustion engine, at least one of valve characteristics including the timing for opening an exhaust valve of the internal combustion engine, the timing for closing the exhaust valve, and the maximum lift of the exhaust valve.

22. The actuator control apparatus according to claim 21, wherein
the actuator is a variable valve mechanism operable to change the maximum lift of the exhaust valve.

23. The actuator control apparatus according to claim 17, wherein
the actuator is an electrically-driven actuator.

24. The actuator control apparatus according to claim 17, wherein
the actuator is operable to change the opening degree of a throttle valve of the internal combustion engine as the state amount of the internal combustion engine, and the sensor is adapted to detect the actual opening degree of the throttle valve by detecting the actual operation position of the actuator.

25. An actuator control apparatus, comprising:
an actuator provided in an internal combustion engine at a position distant from a combustion chamber and operable to change a state amount of the internal combustion engine;
a sensor that detects an actual operation position of the actuator;
a controller that controls the actuator so as to bring the actual operation position of the actuator to a target operation position set based on an operation state of the internal combustion engine;
a diagnosis portion that diagnoses the actuator to be in an abnormal state when the deviation of the actual operation position from the target operation position has been larger than a reference amount for a reference time; and
a setting portion that, upon the diagnosis by the diagnosis portion, sets the reference amount such that the lower the temperature of engine coolant, the larger the reference amount and sets the reference time such that the lower an ambient temperature around the internal combustion engine, the longer the reference time.

26. The actuator control apparatus according to claim 25, wherein
the ambient temperature around the internal combustion engine is detected by an intake air temperature sensor provided at the internal combustion engine.

27. The actuator control apparatus according to claim 25, wherein
the actuator is operable to change, as the state amount of the internal combustion engine, at least one of valve characteristics including the timing for opening an intake valve of the internal combustion engine, the timing for closing the intake valve, and the maximum lift of the intake valve.

28. The actuator control apparatus according to claim 27, wherein
the actuator is a variable valve mechanism operable to change the maximum lift of the intake valve.

29. The actuator control apparatus according to claim 25, wherein
the actuator is operable to change, as the state amount of the internal combustion engine, at least one of valve characteristics including the timing for opening an exhaust valve of the internal combustion engine, the timing for closing the exhaust valve, and the maximum lift of the exhaust valve.

30. The actuator control apparatus according to claim 29, wherein
the actuator is a variable valve mechanism operable to change the maximum lift of the exhaust valve.

31. The actuator control apparatus according to claim 25, wherein
the actuator is an electrically-driven actuator.

32. The actuator control apparatus according to claim 25, wherein
the actuator is operable to change the opening degree of a throttle valve of the internal combustion engine as the state amount of the internal combustion engine, and the sensor is adapted to detect the actual opening degree of the throttle valve by detecting the actual operation position of the actuator.
